(19) United States
(12) Patent Application Publication
(10) Pub. No.: US 2004/0165893 A1
(43) Pub. Date: Aug. 26, 2004

(54) Optical modulator

(76) Inventor: Peter J. Winzer, Tinton Falls, NJ (US)

Correspondence Address: Steve Mendelsohn, Mendelsohn & Associates, P.C., Suite 715, 1515 Market Street, Philadelphia, PA, 19102, US

(21) Appl. No.: 10/649,102

(22) Filed: Aug. 27, 2003

Related U.S. Application Data
(60) Provisional application No. 60/448,735, filed on Feb. 20, 2003.

(51) Int. Cl. H04B 10/00

(52) U.S. Cl. 398/161

(57) ABSTRACT

A method and apparatus for optical return-to-zero (RZ) modulation based on a single Mach-Zehnder modulator driven by non-return-to-zero (NRZ) electrical signals. The method and apparatus allow for continuously electrically tunable duty cycles and lead to chirped-RZ formats. A “push-pull” embodiment involves driving one control arm of the Mach-Zehnder with a differentially encoded version of an NRZ data stream and driving the other control arm with an inverted and time-delayed copy of the same differentially encoded data stream. A “push-push” embodiment involves driving one control arm of the Mach-Zehnder with a differentially encoded version of an NRZ data stream and driving the other control arm with a time-delayed but non-inverted copy of the same differentially encoded data stream. In one or more embodiments, the duty cycle of the RZ modulation is controlled via the selection of the time delay between the electrical signals that drive the two arms of the Mach-Zehnder.

### CROSS-REFERENCE TO RELATED APPLICATIONS

This application claims the benefit of the filing date of U.S. provisional application No. 60/448,735, filed on Feb. 20, 2003.

### BACKGROUND OF THE INVENTION

1. Field of the Invention

This invention relates generally to the field of optical telecommunications, and in particular, to return-to-zero (Rz) modulators in optical transmitters.

2. Description of the Related Art

In the field of optical communications, RZ formats are often preferred over non-return-to-zero (NRZ) formats due to their increased robustness to a variety of distortions that are typically encountered in optical fiber propagation and in filtering and reception.

The most commonly employed RZ transmitter structures make use of an NRZ data modulator either in combination with a sinusoidally driven intensity modulator acting as a pulse carver, or in combination with an actively mode-locked laser. Efforts to reduce RZ transmitter complexity have led to designs that (i) use a single electro-optic modulator fed by an electrical RZ signal, (ii) employ an NRZ-driven phase modulator followed by a passive optical delay interferometer, or (iii) drive a Mach-Zehnder intensity modulator between its transmission minima with an NRZ signal to generate RZ pulses upon level changes in the NRZ drive signal.

More information on designs (i), (ii), and (iii) can be found in: N. M. Froberg et al., “Generation of 12.5 Gbit/s soliton data stream with an integrated laser-modulator transmitter,” Electron. Lett., vol. 30, 1880-1881 (1994); P. J. Winzer and J. Leuthold, “Return-to-Zero Modulator Using a Single NRZ Drive Signal and an Optical Delay Interferometer,” Photon. Technol. Lett., vol. 13, 1298-1300 (2001) (herein “Winzer '01”); and J. J. Veselka et al., “A soliton transmitter using a cw laser and an NRZ driven Mach-Zehnder modulator,” Photon. Technol. Lett., vol. 8, 950-952 (1996), respectively, each incorporated herein by reference in its entirety.

As the demand for more bandwidth grows, the market pressure to reduce the cost, size, and complexity of RZ transmitters increases.

### SUMMARY OF THE INVENTION

Problems in the prior art are addressed in accordance with principles of the present invention by a method and apparatus for optical return-to-zero (RZ) modulation that are based on a single Mach-Zehnder modulator driven by non-return-to-zero (NRZ) electrical control signals. The method and apparatus allow for continuously electrically tunable duty cycles and lead to chirped-RZ formats. One embodiment, a “push-pull” operation, involves driving one control arm of the Mach-Zehnder with a differentially encoded version of an NRZ data stream and driving the other control arm with an inverted and time-delayed copy of the same differentially encoded data stream. Another embodiment, a “push-push” operation, involves driving one control arm of the Mach-Zehnder with a differentially encoded version of an NRZ data stream and driving the other control arm with a time-delayed but non-inverted copy of the same differentially encoded data stream. In one or more embodiments, the duty cycle of the RZ modulation is controlled via the selection of the time delay between the electrical signals that drive the two arms of the Mach-Zehnder.

In one embodiment, the present invention is an apparatus for generating a modulated optical signal. The apparatus includes a signal splitter adapted to receive and split an input data signal into first and second copies, a delay element adapted to receive and delay the first copy relative to the second copy, and an optical signal modulator adapted to modulate light fed to the modulator in accordance with first and second control signals based on the delayed first copy and the second copy, respectively, to generate the modulated optical signal.

In another embodiment, the present invention is a method for generating a modulated optical signal. The method involves splitting an input data signal into first and second copies, delaying the first copy relative to the second copy, and modulating light based on the delayed first copy and the second copy to generate the modulated optical signal.

### BRIEF DESCRIPTION OF THE DRAWINGS

Other aspects, features, and advantages of the present invention will become more fully apparent from the following detailed description, the appended claims, and the accompanying drawings in which:

FIG. 1 depicts two different embodiments of a chirped-RZ transmitter according to the present invention.

FIG. 2 depicts exemplary waveforms for the intensity and phase of the signal out of the Mach-Zehnder modulator for the push-pull configuration (FIG. 2(a)) and the push-push configuration (FIG. 2(b)).

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

The Transmitters

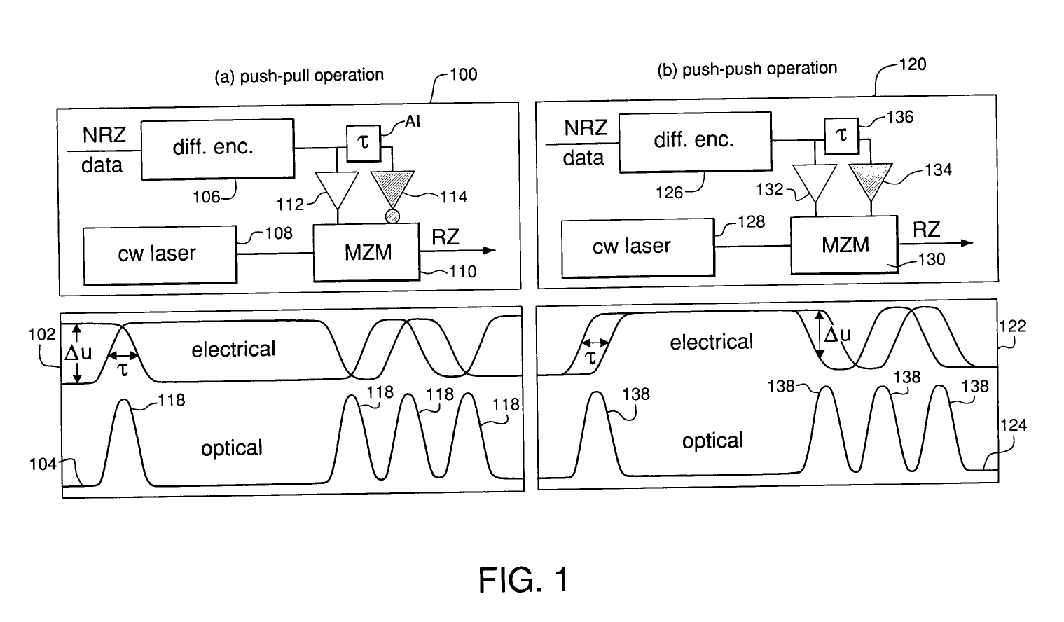

FIG. 1 depicts two different embodiments of a chirped-RZ transmitter according to the present invention. These embodiments represent modifications of duobinary and alternate-mark-inversion NRZ transmitters. For duobinary signaling, a phase change occurs whenever there is an odd number of ‘0’s between two successive ‘1’s, whereas for AMI the phase changes for each ‘1’ (even for adjacent ‘1’s), independent of the number of ‘0’s in between. More information on such transmitters can be found in T. Franck et al., “Duobinary transmitter with low intersymbol interference,” Photon. Technol. Lett., vol. 10, 597-599 (1998) (herein “Franck '98”), incorporated herein by reference in its entirety.. As discussed in the following, each transmitter results in a modulated optical output signal that exhibits a unique set of characteristics.

Push-Pull

FIG. 1(a) depicts a “push-pull” embodiment of chirped-RZ (CRZ) transmitter 100, as well as associated electrical and optical waveforms 102 and 104, respectively, according to one embodiment of the present invention.

CRZ transmitter 100 includes (optional) differential encoder 106, continuous-wave (CW) laser 108, dual-drive Mach-Zehnder modulator (MZM) 110, non-inverting driver amplifier 112, inverting driver amplifier 114, and variable delay element 116 of delay τ.

Operationally, CW laser 108 feeds MZM 110 with an optical signal that is modulated by the MZM with a differentially encoded representation of an electrical NRZ data signal that has a bit period of T seconds. In particular, differential encoder 106 receives the electrical NRZ data signal and translates it to a differentially encoded signal that is split into two paths. One path is fed to non-inverting driver amplifier 112, which drives one electrical control arm of MZM 110. The second path feeds delay element 116 where the signal is delayed by τ seconds, where τ≦T. The delayed signal out of the delay element is then fed to inverting driver amplifier 114, which drives the other control arm of MZM 110. Electrical waveforms 102 correspond to the differentially encoded signal from driver amplifier 112 and the inverted, delayed, differentially encoded signal from driver amplifier 114.

The differential encoder operates by translating each occurrence of a logical “1” in the electrical NRZ data signal into a level change on the encoder's output. For example, an NRZ data signal representing the bit pattern 1000111 would be encoded as SNNNSSS, where S denotes a level shift and N denotes no level shift. Such a differential encoding scheme is discussed in more detail in Franck '98. Note that it is not strictly necessary to precode the signals at the transmitter. In an alternative implementation, the differential encoder can be omitted, the MZM can be modulated with the uncoded NRZ data signal, and appropriate decoding can be done at the receiver, as would be understood by one skilled in the art. However, in practice, precoding at the transmitter leads to a more noise-tolerant system than performing decoding at the receiver.

Note that MZM 110 is biased for destructive interference in the absence of drive level changes between its control arms. Thus, the output power of the MZM in the absence of level transitions is essentially zero. However, as a result of changes in the control arm drive voltages (see, for example, waveforms 102) that result from logical ones in the electrical NRZ data signal, pulses are produced (e.g., pulses 118 of waveform 104) in the output of the MZM corresponding to where the interference properties of the MZM are altered by the two modulating electrical NRZ waveforms 102. The duration of each pulse (i.e., its pulsewidth) is determined by the electrical delay τ and the rise/fall times of the MZM control arm drive signals.

Push-Push

FIG. 1(b) depicts a “push-push” embodiment of chirped-RZ transmitter 120, as well as associated electrical and optical waveforms 122 and 124, respectively, according to another embodiment of the present invention.

CRZ transmitter 120 includes (optional) differential encoder 126, continuous-wave laser 128, dual-drive Mach-Zehnder modulator 130, non-inverting driver amplifiers 132 and 134, and delay element 136 of delay τ.

Operationally, it should be noted that corresponding elements of CRZ transmitter 120 behave similarly to those of CRZ transmitter 100. Namely, CW laser 128 feeds MZM 130 with an optical signal that is modulated by the MZM with a differentially encoded representation of an electrical NRZ data signal that has a bit period of T seconds. In particular, differential encoder 126 receives the electrical NRZ data signal and translates it to a differential signal, still in NRZ format. The resulting differentially encoded signal is split into two paths. One path is fed to non-inverting driver amplifier 132, which drives one electrical control arm of MZM 130. The second path feeds delay element 136 where the signal is delayed by τ seconds, where τ≦T. The delayed signal out of the delay element is then fed to non-inverting driver amplifier 134, which drives the other control arm of MZM 130. Electrical waveforms 122 correspond to the differentially encoded signal from driver amplifier 132 and the delayed, differentially encoded signal from driver amplifier 134.

MZM 130 is biased for destructive interference in the absence of drive level changes between its control arms. Thus, the output power of the MZM in the absence of level transitions is essentially zero. However, as a result of changes in the control arm drive voltages (see, for example, waveforms 122) that result from logical ones in the electrical NRZ data signal, pulses are produced (e.g., pulses 138 of waveform 124) in the output of the MZM corresponding to where the interference properties of the MZM are altered. The duration of each pulse (i.e., its pulsewidth) is determined by the electrical delay τ and the rise/fall times of the MZM control arm drive signals.

Pulsewidth and Waveform Characteristics

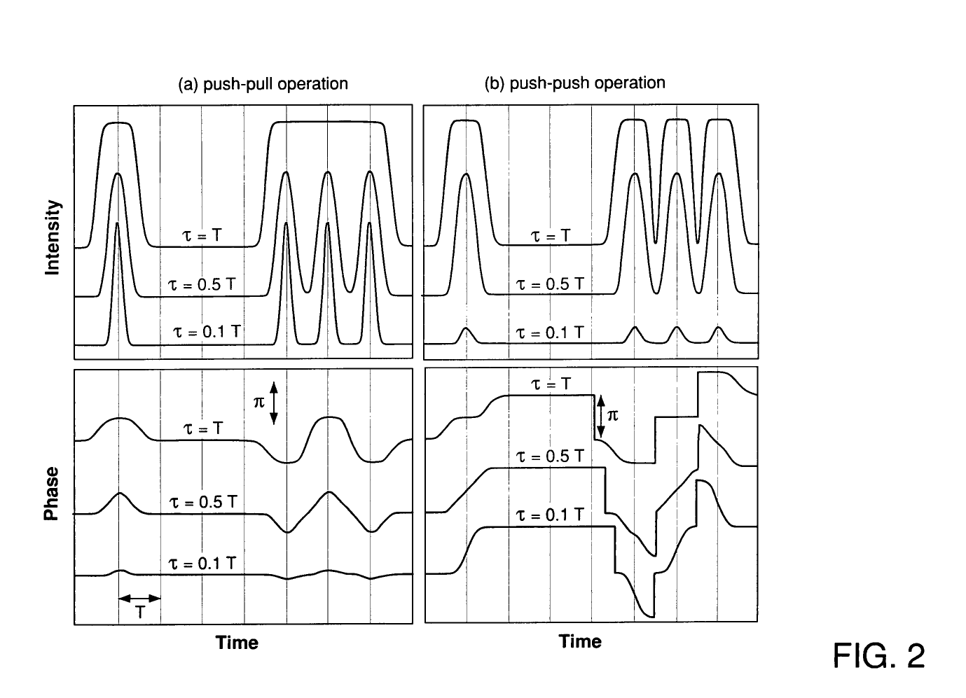

FIG. 2 depicts exemplary waveforms for the intensity and phase of the signal out of the MZM for the push-pull configuration (e.g., FIG. 2(a)) and the push-push configuration (e.g., FIG. 2(b)) for electrical delays of τ equal to T, 0.5·T, and 0.1·T. In each case, the electrical MZM control signal is assumed to have a 10%-90% rise time of 0.4·T, corresponding to a moderate drive bandwidth of 0.9/T. The drive levels of the control signals are chosen equal to the MZM's switching voltage V_{π}. This results in destructive interference at the output of the MZM under nominal circumstances (e.g., NRZ data=0). As shown in FIG. 2, relatively short RZ pulses can be generated without the need for exceedingly high electrical-drive bandwidths.

One difference between the push-pull embodiment and the push-push embodiment is that the push-pull embodiment yields a substantially constant peak pulse power, independent of τ, while the peak pulse power decreases with τ in the push-push implementation. This is because, for push-pull operation, the drive-voltage difference Δμ(t)=Δ₁(t)−μ₂(t) between the two MZM control arms, which is responsible for the optical power transmission of the MZM, always passes a transmission maximum at Δμ(t)=0 when switching between the transmission minima that are present at Δμ(t)=V_{π}−0 and Δμ(t)=0−V_{π} (i.e., the voltage differences associated with no control arm drive level changes).

For push-push operation, on the other hand, constructive interference in the MZM, leading to RZ-pulse peaks, is found at times of maximum drive voltage difference Δu . As can be seen from FIG. 1(b), this difference is reduced once τ falls short of the modulation rise time. To avoid the excess modulation insertion loss introduced by this effect, the drive voltage can be increased. Conversely, in circumstances when a higher modulator insertion loss is acceptable, the push-push embodiment may be used for control arm drive voltages smaller than V_{π}, while the push-pull implementation involves drive levels substantially equal to V_{π} on both arms of the MZM, or degradations in extinction ratio will be encountered.

Regarding the phase of the optical pulses, FIG. 2(a) reveals that the push-pull implementation yields alternate-chirp RZ signals, with lower phase excursions at reduced duty cycles. Signals of this kind can offer potential advantages for non-linear fiber propagation as discussed in R. Ohhira, D. Ogasahara, and T. Ono, “Novel RZ signal format with alternate-chirp for suppression of nonlinear degradation in 40 Gb/s based WDM,” Proc. OFC'01, paper WM2 (2001), incorporated herein by reference in its entirety.

The push-push implementation, on the other hand, in addition to a π-phase jump for every RZ pulse (see FIG. 2(b)), typically generates linear phase transitions of alternating sign over the pulse duration. In other words, it lets adjacent pulses experience opposite frequency shifts, as discussed in Winzer '01. In the limit as τ→T and as the rise and fall times of the control arm drive signals approach zero, both embodiments of the present invention can produce unchirped, alternate-mark-inversion, NRZ signals out of the MZM.

Note that various alternative implementations may be substituted for the exemplary implementations illustrated in FIGS. 1(a) and 1(b). For example, a push-push implementation that replaces each non-inverting driver amplifier (132 and 134) in the embodiment of FIG. 1(b) with an inverting driver amplifier, two inverting driver amplifiers, or no driver amplifiers at all (assuming drive levels from the differential encoder were sufficient) would be within the spirit and scope of the present invention. Similarly, in the push-pull implementation of FIG. 1(a), equivalent arrangements of driver amplifiers including swapping the location of inverting and non-inverting driver amplifiers (114 and 112), while making appropriate voltage offset adjustments, using no driver amplifier in place of non-inverting driver amplifier 112 while using inverting driver amplifier 114, and other equivalent arrangements as would be understood by one skilled in the art, would remain within the scope and spirit of the present invention.

Also, a splitter, as described herein, should be understood to include any active or passive electronic device that produces two substantially identical or logically inverted copies of one data stream as would be understood to one skilled in the art. Similarly, the process of splitting should be understood to include any active or passive process that produces two substantially identical or logically inverted copies of one data stream.

Additionally, it should be noted that, in the push-pull embodiment of the present invention depicted in FIG. 1(a), the order of delay component 116 and inverting driver amplifier 114 maybe reversed (i.e., the signal out of differential encoder 106 maybe split and amplified, inverted, and then delayed before being fed to MZM 110) while remaining within the scope of the present invention. Alternatively, driver amplifier 112 and inverting driver amplifier 114 can be deleted and a single dual-output (one output invert) driver amplifier can be inserted after differential encoder 106. In this alternative arrangement, one output of the dual-output driver amplifier is fed to delay element 116, which in turn feeds MZM 110 and the other output is fed to MZM 110 directly.

In a similar manner, in the push-push embodiment of the present invention depicted in FIG. 1(b), the order of delay component 136 and driver amplifier 134 may be reversed. Alternatively, driver amplifiers 132 and 134 can be deleted and a single dual-output driver amplifier can be inserted after differential encoder 126. In this alternative arrangement, one output of the dual-output driver amplifier is fed to delay element 136, which in turn feeds MZM 130 and the other output is fed MZM 130 directly. Alternatively, in the latter arrangement, the driver amplifier may be of the single output variety and a single output lead from the driver amplifier can be directly split or fed to a printed-circuit board trace that is then split between the delay element and the direct feed to the MZM. Other equivalent arrangements are within the scope and spirit of the present invention as would be understood to one skilled in the art.

Note that the elements of the present invention may be implemented by various techniques and in various technologies while remaining within the spirit and scope of the invention. These techniques and technologies include, but are not limited to, integrated optics (including silica on silicon substrate or Si:SiO₂), fiber optics, free space optics, thin film, InGaAs, InP, and LiNbO₃ subsystems.

Note that in one or more embodiments of the present invention, variable delay elements 116 and 136 of FIGS. 1 (a) and 1 (b), respectively, can be dynamically configured by an integrated or external controller (not illustrated).

While this invention has been described with reference to illustrative embodiments, this description should not be construed in a limiting sense. Various modifications of the described embodiments, as well as other embodiments of the invention, which are apparent to persons skilled in the art to which the invention pertains are deemed to lie within the principle and scope of the invention as expressed in the following claims.

What is claimed is:

1. An apparatus for generating a modulated optical signal, the apparatus comprising:
a signal splitter adapted to receive and split an input data signal into first and second copies;
a delay element adapted to receive and delay the first copy relative to the second copy; and
an optical signal modulator adapted to modulate light fed to the modulator in accordance with first and second control signals based on the delayed first copy and the second copy, respectively, to generate the modulated optical signal.

2. The invention of claim 1, further comprising a differential encoder adapted to receive and differentially encode a non-differentially encoded data signal to produce the input data signal.

3. The invention of claim 2, wherein the differentially encoded data signal is level shifted in response to receiving a logical one in the non-differentially encoded data signal.

4. The invention of claim 2, wherein the non-differentially encoded data signal is an NRZ data signal.

5. The invention of claim 1, wherein the delay of the delay element is dynamically configurable.

6. The invention of claim 1, wherein a logical one in the input data signal results in an intensity pulse in the modulated optical signal, wherein the intensity pulse has a pulsewidth that is a function of the delay.

7. The invention of claim 1, further comprising an inverter adapted to invert the delayed first copy to generate the first control signal.

8. The invention of claim 1, wherein the optical signal modulator is a dual-drive Mach-Zehnder.

9. The invention of claim 1, further comprising a CW laser adapted to generate the light.

10. The invention of claim 1, wherein the modulated optical signal is a chirped-RZ signal.

11. The invention of claim 1, wherein the input data signal is derived from an electrical NRZ signal.

12. The invention of claim 1, wherein the delay is less than or equal to a bit period of the input data signal.

13. The invention of claim 1, further comprising:
a first driver amplifier adapted to couple the delayed first copy to the modulator; and
a second driver amplifier adapted to couple the second copy to the modulator.

14. The invention of claim 13, wherein one of the first and second driver amplifiers is an inverting driver amplifier and the other is a non-inverting driver amplifier.

15. The invention of claim 13, wherein the first and second driver amplifiers are either both non-inverting driver amplifiers or both inverting driver amplifiers.

16. The invention of claim 1, further comprising:
a CW laser adapted to generate the light;
a differential encoder adapted to receive and differentially encode an electrical NRZ data signal to produce the input data signal;
a first driver amplifier adapted to couple the delayed first copy to the modulator; and
a second driver amplifier adapted to couple the second copy to the modulator, wherein:
the delay of the delay element is dynamically configurable;
the delay is less than or equal to a bit period of the input data signal;
the optical signal modulator is a dual-drive Mach-Zehnder;
the modulated optical signal is a chirped-RZ signal;
a logical one in the input data signal results in an intensity pulse in the modulated optical signal, wherein the intensity pulse has a pulsewidth that is a function of the delay.

17. The invention of claim 16, wherein one of the first and second driver amplifiers is an inverting driver amplifier and the other is a non-inverting driver amplifier.

18. The invention of claim 16, wherein the first and second driver amplifiers are either both non-inverting driver amplifiers or both inverting driver amplifiers.

19. A method for generating a modulated optical signal, the method comprising:
splitting an input data signal into first and second copies;
delaying the first copy relative to the second copy; and
modulating light based on the delayed first copy and the second copy to generate the modulated optical signal.

20. The invention of claim 19, further comprising differentially encoding a non-differentially encoded data signal to produce the input data signal.

21. The invention of claim 20, wherein the input data signal is level shifted in response to receiving a logical one in the non-differentially encoded data signal.

22. The invention of claim 20, wherein the non-differentially encoded data signal is an NRZ data signal.

23. The invention of claim 19, wherein the magnitude of the delay is dynamically configurable.

24. The invention of claim 19, wherein a logical one in the input data signal results in an intensity pulse in the modulated optical signal, wherein the intensity pulse has a pulsewidth that is a function of the delay.

25. The invention of claim 19, wherein the delayed first copy is inverted prior to being applied to the modulator as the first control signal.

26. The invention of claim 19, wherein the light is generated by a CW laser.

27. The invention of claim 19, wherein the modulated optical signal is a chirped-RZ signal.

28. The invention of claim 19, wherein the input data signal is derived from an electrical NRZ signal.

29. The invention of claim 19, wherein the delay is less than or equal to a bit period of the input data signal.

30. The invention of claim 19, wherein:
the delayed first copy is coupled to the modulator via a first driver amplifier; and
the second copy is coupled to the modulator via a second driver amplifier.

31. The invention of claim 30, wherein one of the first and second driver amplifiers is an inverting driver amplifier and the other is a non-inverting driver amplifier.

32. The invention of claim 30, wherein the first and second driver amplifiers are either both non-inverting driver amplifiers or both inverting driver amplifiers.

33. An apparatus for generating a modulated optical signal, the apparatus comprising:
means for splitting an input data signal into first and second copies;
means for delaying the first copy relative to the second copy; and
means for modulating light based on the delayed first copy and the second copy to generate the modulated optical signal.
